(19) United States
(12) Patent Application Publication
(10) Pub. No.: US 2014/0033027 A1
(43) Pub. Date: Jan. 30, 2014

(54) E-Book Application with Multi-Document Display

(71) Applicants: Michael Joseph Polo, Huntley, IL (US); Sarah Anne Helvie, Grayslake, IL (US); Douglas Benjamin Lavin, New York, NY (US); Barnabe Cargill, New York, NY (US); Raymond Maurice Blijd, Amsterdam (NL); John Paul Chatelaine, Lakeville, MN (US)

(72) Inventors: Michael Joseph Polo, Huntley, IL (US); Sarah Anne Helvie, Grayslake, IL (US); Douglas Benjamin Lavin, New York, NY (US); Barnabe Cargill, New York, NY (US); Raymond Maurice Blijd, Amsterdam (NL); John Paul Chatelaine, Lakeville, MN (US)

(21) Appl. No.: 13/833,486

(22) Filed: Mar. 15, 2013

Related U.S. Application Data
(60) Provisional application No. 61/670,951, filed on Jul. 12, 2012.

(51) Int. Cl. G06F 17/21

(52) U.S. Cl. CPC G06F 17/212
USPC 715/252

(57) ABSTRACT

A processor operating an e-book application may receive a first message at a user device representing a first electronic document to be displayed in a first portion of a viewable display area of the user device. The processor may automatically size the first document to fill the first portion of the viewable display area, where the first portion of the viewable display area is less than all of the viewable display area of the user device. A second user message may be received by the processor representing a second electronic document to be displayed in a second portion of the viewable display area. The processor may automatically size the second electronic document to fill the second portion of the viewable display area being a difference between the viewable display area and the first portion of the viewable display area.

### PRIORITY CLAIM

This application claims the benefit of priority from U.S. Provisional Application No. 61/670,951, filed Jul. 12, 2012, which is incorporated by reference.

### BACKGROUND OF THE INVENTION

1. Technical Field

This application relates to electronic books, and more particularly the display of multi-documents within a single application.

2. Related Art

It used to be that in the publishing industry publications referred to books and documents that were printed or copied onto physical sheets of paper. This, however, is no longer the case. Nowadays, these older books and documents may also be available in digital form. New publications are sometimes only generated in digital form.

E-book applications allow a user to read these digital publications on computing devices. Generally, an e-book is a document that is formatted to be paginated on the display of a computing device. A single page of the e-book is typically displayed on the computing device. Through user interaction with the display screen or another input device, associated with the computing device, a user can advance to a next page or preceding page. Some e-book applications may display two consecutive pages of the e-book when the orientation of the computing device's screen is rotated.

Some e-book applications allow a user to navigate to a specific page within the e-book, or to move forwards or backwards within the e-book by predefined sections (e.g., chapters) or sub-sections. Generally, when a user jumps forwards or backwards within the e-book, a single page of the c-book is displayed to the user. In some instances, the orientation of the computing device may again cause two consecutive pages to be displayed to the user at the jumped to location.

It is not uncommon for a user to want to read, or compare, two non-consecutive pages of a book. In these situations, a user has to navigate back and forth between the non-consecutive pages of the e-book. In instances where a user is interested in reading, or comparing, portions of separate e-books, the user is required to switch between entirely different e-books. Therefore, there is a need for an e-book application that allows users to easily display, and navigate, non-consecutive pages of an e-book. There is also a need for users to simultaneously display, and navigate, pages from different c-books.

### SUMMARY

An electronic book (e-book) application with multi-document display allows users to simultaneously display and independently interact with multiple electronic documents. A processor operating an e-book application may receive a first message at a user device representing a first electronic document to be displayed in a first portion of a viewable display area of the user device. The processor may automatically size the first document to fill the first portion of the viewable display area, where the first portion of the viewable display area is less than all of the viewable display area of the user device. A second message may be received by the processor representing a second electronic document to be displayed in a section portion of the viewable display area. The processor may automatically size the second electronic document to fill the second portion of the viewable display area, the second portion of the viewable display area being a difference between the viewable display area and the first portion of the viewable display area.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is an illustrative example of an embodiment of a user device that may implement an e-book application.

FIG. 2 illustrates an embodiment of the user device where the e-book application displays multiple electronic documents.

FIG. 3 illustrates an embodiment of the user device where non-consecutive sections of an electronic book are simultaneously displayed on the user device.

FIG. 4 illustrates an embodiment of the user device where pages of different electronic books are simultaneously displayed on the user device.

FIG. 5 is an exemplary flow diagram that displays multiple documents through an electronic application on a user device.

### DETAILED DESCRIPTION OF THE PREFERRED EMBODIMENTS

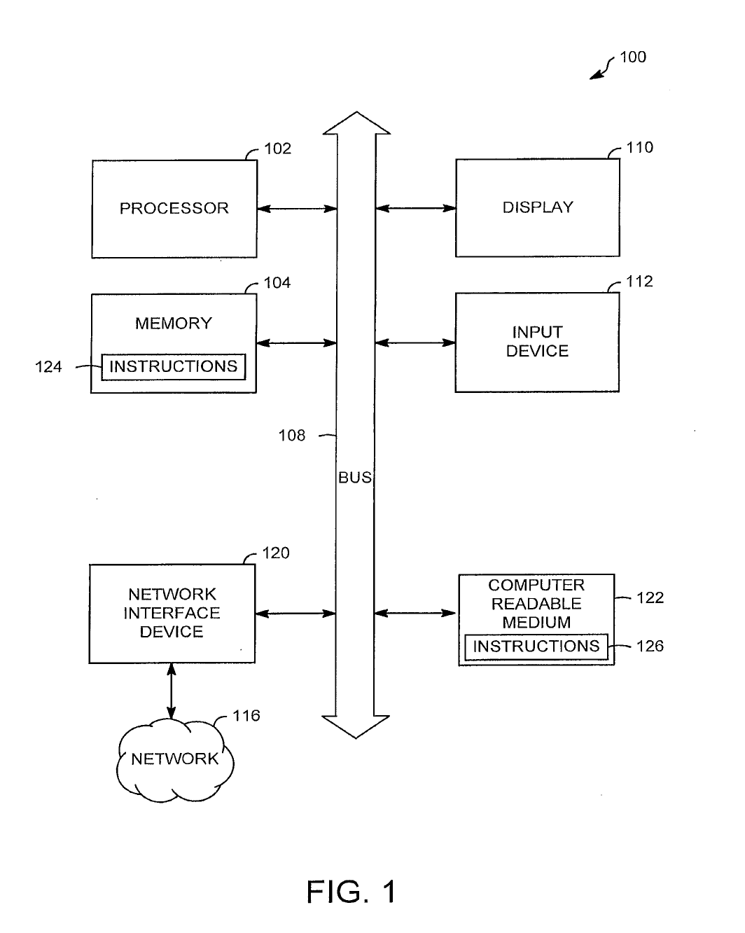

FIG. 1 is an illustrative example of a user device 100 that may implement an electronic book (e-book) application for displaying electronic documents. The user device 100 may include a processor 102, such as a central processing unit (CPU), a graphics processing unit (GPU), or both. The processor 102 may be one or more general processors, digital signal processors, application specific integrated circuits, field programmable gate arrays, digital circuits, analog circuits, combinations thereof, or other now known or later developed devices for analyzing and processing data. The processor 102 may implement a software program, such as code generated manually (i.e., programmed). Examples of user device 100 include, but are not limited to, a personal computer, personal digital assistant (“PDA”), tablet, tablet computer, smartphone, television or other electronic device.

The user device 100 may include a memory 104 that can communicate via a bus 108. The memory 104 may be a main memory, a static memory, or a dynamic memory. The memory may include, but may not be limited to a computer readable storage media such as various types of volatile and non-volatile storage media, including but not limited to random access memory, electrically erasable read-only memory, flash memory, magnetic tape or disk, optical media and the like. In some user devices 100, the memory 104 may include a cache or random access memory for the processor 102. Alternatively, or in addition, the memory 104 may be separate from the processor 102, such as a cache memory of a processor, the system memory, or other memory. The memory 104 may be operable to store instructions 124 executable by the processor 102. The functions, acts, or task illustrated in the figures or described herein may be performed by the programmed processor 102 executing the instructions 124 stored in the memory 104, the instructions 126 stored in the computer-readable medium 122, or both. The functions, acts, or tasks may be independent of the particular type of instruction set, storage media, processor, or processing strategy and may be performed by software, hardware, integrated circuits, firm-ware, micro-code and the like, operating alone or in combination. Likewise, processing strategies may include multiprocessing, multitasking, parallel processing and the like.

The user device 100 may further include a display 110, such as a liquid crystal display (LCD), an organic light emitting diode (OLED), a flat panel display, a solid state display, or other know now or later developed display device for outputting determined information. The display 110 may act as an interface for a user to see the functioning of the processor 102, view and interact with electronic documents processed by the processor 102, or as an interface with the software stored in the memory 104. In particular, the display 110 may allow a user to interact with the processor 102 to view, navigate through, and/or annotate an electronic document retained in memory 104 of the user device.

Performance parameters of the display 110 may be retained in the memory 104 and may be accessible to the processor 102. These performance parameters may indicate the ratio of the horizontal length of the display to the vertical length of the display. The performance parameters may also indicate the total size of the display 110, the viewable space of the display 110, or the resolution of the display. Size related parameters of the display 110 may be measured either on the diagonal or measured by height and width. In some user devices 100, the processor may detect the performance parameters of the display 110.

Additionally, the user device 100 may include an input device 112 configured to allow a user to interact with any of the components of the system 100. The input device 112 may be a number pad, a keyboard, or a cursor control device, such as a mouse, a joystick, touch screen display, remote control or any other device operative to interact with the system 100. In some user devices that include a touch screen display input device 112, the touch screen input device 112 may be incorporated into or integrated with the display 110.

The present disclosure contemplates a computer-readable medium 122 that includes instructions 126 or receives and executes instruction 126 responsive to a propagated signal; so that a device connected to a network 116 may communicate voice, video, audio images, or any other data over the network 116. Further, the instructions 126 may be transmitted or received over the network 116 via a communication interface 120. The computer-readable medium 122 may be separate from memory 104, or alternatively may be retained within memory 104. The communication interface 120 may be a part of the processor 102 or may be a separate component. The communication interface 120 may be created in software or may be a physical connection in hardware. The communication interface 120 may be configured to connect with a network 116, external media, the display 110, or any other components in system 100 or combinations thereof. The connection with the network 116 may be a physical connection, such as a wired Ethernet connection, or may be established wirelessly as discussed below. Likewise, the additional connections with other components of the user device 100 may be physical connections or may be established wirelessly.

The network 116 may include wired networks, wireless networks, or combinations thereof. The wireless networks may be a cellular telephone network, an IEEE 802.11, 802.16, 802.20, or WiMax network. Further, the network 116 may be a public network, such as the Internet, a private network, such as an intranet, or combinations thereof, and may utilize a variety of networking protocols now available or later developed including, but not limited to TCP/IP based network protocols. The network may include one or more local area network (LAN), a wide area network (WAN), a direct connection, such as through a Universal Serial Bus (USB) port, and the like, may include any communication method or employ any form of machine-readable media for communication information from one device to another. For example, the user device 100 may receive electronic documents received from a server, publishing service, third-party, or the like, over a network such as the network 116. Additionally, one or more set of instructions 124, 126, or both may be downloaded through the network 116 from a remote computer. Further updates to these instructions may be downloaded to the user device through the network 116 or may be pushed to the user device 100 through the network 116.

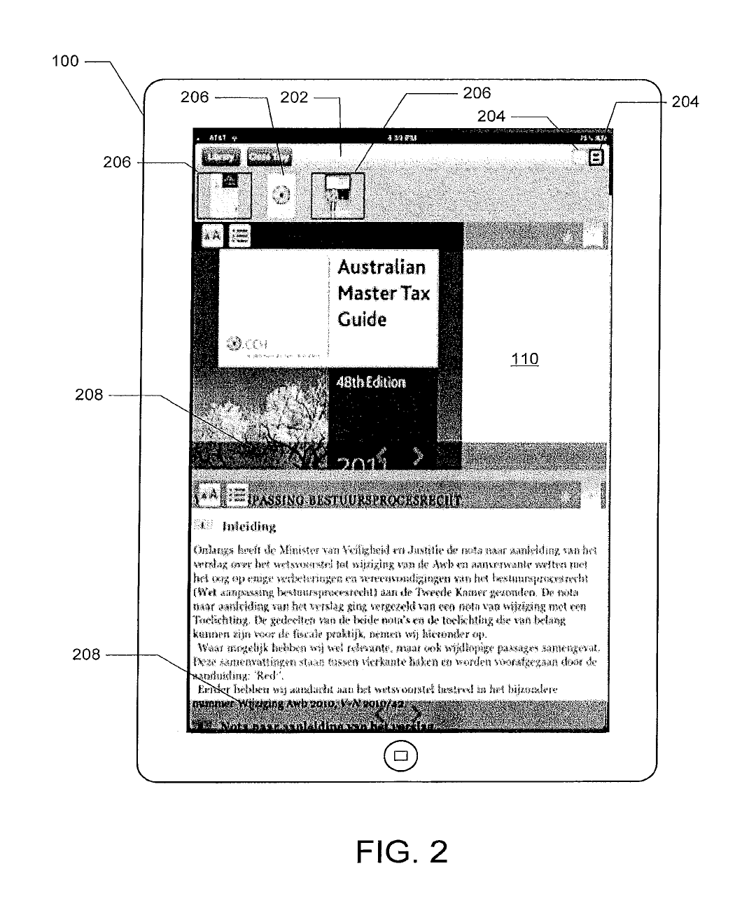

FIG. 2 illustrates an embodiment of the user device 100 where the electronic book application displays multiple electronic documents. A menu bar 202 may be displayed in response to a user touching a portion of the display 110. From the menu bar, the user may select a multi-view icon 204. In response to the user's selection of the multi-view icon 204, the processor 102 may cause the display 110 to display a listing of icons 206 representative of a library of electronic documents that have been downloaded or pushed to the user device 100 through the network 116. Examples of electronic documents include, but are not limited to, documents that encapsulate a complete description of a fixed-layout document, including text, fonts, graphics, and other information needed to display it, such Portable Document Format (“PDF”) documents, documents designed for reflowable content where the text display may be optimized for the particular display device used, such as the EPub open e-book standard developed by the International Digital Publishing Forum, or other electronic document formats, such as electronic word processing, electronic spreadsheet, or web page format files. A user may select a first electronic document icon by tapping or dragging and dropping it into a viewing area of the user device. Upon selection of the selected first icon, the processor 102 causes the display 110 to display the associated electronic document in scaled down size. For example, the selected electronic document may be displayed as approximately 50 percent of the available viewing area of the display 110. In some configurations, the available viewing area of the display 110 may include the area of the display 110 that does not display one or more tool bars and that excludes any margin area of the display 110 that may be used for alternative inputs, such as a page navigation input. The scaled version of the first selected electronic document may automatically fill the scaled down portion of the display without any additional user input. The user may then select a second electronic document icon by tapping or dragging and dropping the icon into the viewing area of user device. Upon selection of the selected second icon, the processor 102 causes the second associated electronic document to fill the remaining portion of the display without any additional user input (e.g., the remaining approximately 50 percent of the available viewing area). In some user devices, the display of the multiple documents may be a combination of other than approximately 50 percent each of the available viewing area, such as approximately 60 percent: approximately 40 percent, respectively, or another combination that utilizes the entire available viewing area. In yet other configurations, more than two electronic documents may be displayed at the same time.

In FIG. 2, each displayed document has its own separate navigation control bar 208 that may be accessed when a user single taps an interior portion of the viewing area for the respective electronic document. Additionally, each electronic document may be viewed, navigated, annotated, and the like, independently. The user device 100 is programmed to recognize which electronic document the user is interacting with (e.g., navigating, annotating, searching, bookmarking, etc.) upon interaction with the respective portion of the display. In other words, a user is not required to first select a portion of the display with which the user desires to interact. Instead, if the user desires to turn a page of the second electronic document, in response to the user issuing a turn page command (either through the respective navigation bar 208 which may include individual page forward and page back inputs, or through another page turning command, such as a finger swipe across the display) the user device 100 will respond for that respective document. Some user devices may be configured such that a portion of the display 110 along a margin may activate a page forward or page backwards action. In these devices, a user can, for example, advance an electronic book forward one or more pages at a time by touching or holding a right side margin of the display. Similarly, a user could advance an electronic book backwards one or more pages at a time by touching or holding a left side margin of the display. In some devices, other margins portions of the display may be used to change pages of the electronic book. Additionally, an input (touch, stylus, mouse movement, etc.) dragged across a respective electronic document may permit the view of the document to be panned in accordance with the movement of the input. Accordingly, a user may move the electronic document, left, right, up, or down with a dragged input to see portions of the electronic document that are currently viewable.

Some user devices 100 are orientation aware. Thus, if the user device 100 is rotated from its shown portrait orientation to a landscape orientation, the processor 102 will automatically cause the multiple displayed documents to likewise rotate and follow a landscape view. When selecting the electronic documents to view in the multiple display mode, a user can select different documents, or can alternatively select multiple instances of the same electronic document. In this latter situation, a user is able to view non-consecutive pages of the same electronic document at the same time.

When the user is desires to return to viewing a single document, a single mode icon 210 may be selected. Some user devices 100 may be programmed such that in response to selecting the single mode icon the processor 102 causes the last interacted with electronic document to be displayed full screen in a single viewing mode. Alternatively, other user devices 100 may be programmed such that in response to the selecting the single mode icon, the processor 102 causes the list of library icons 206 to be re-displayed giving the user the option of which electronic document will be displayed full screen in single viewing mode. In response to the user making a selection from the list of library icons 206, the processor 102 causes the display 110 to display the selected electronic document.

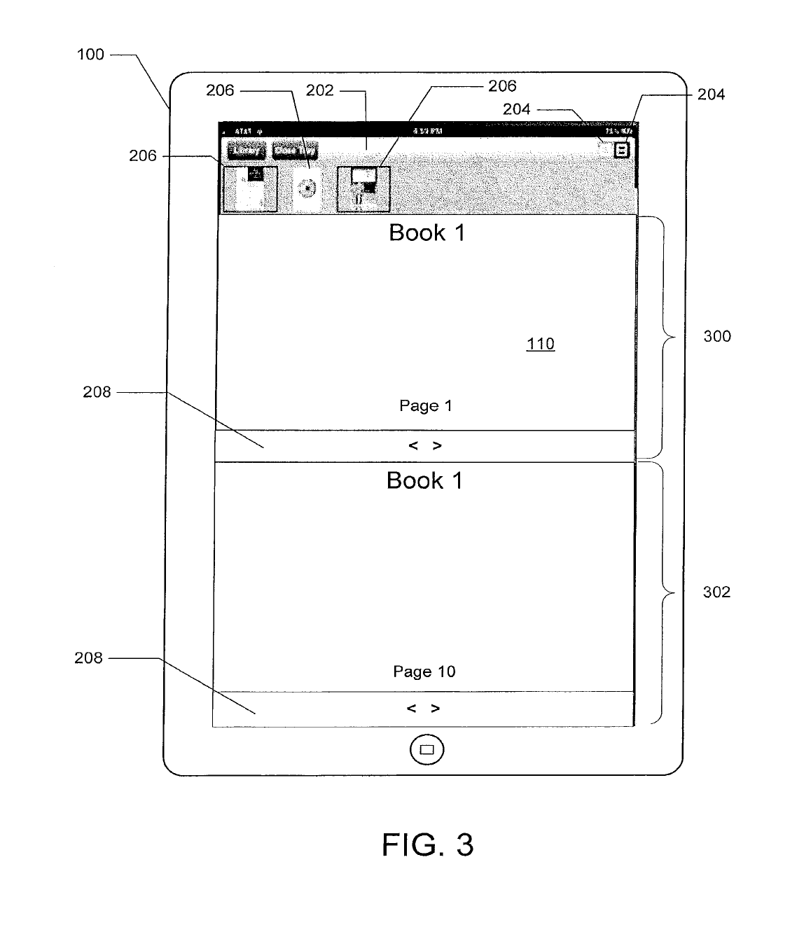

FIG. 3 illustrates an embodiment of the user device 100 where non-consecutive sections of an electronic book are simultaneously displayed on the user device 100. In an upper portion 300 of the display 110 of the user device 100 a first page of an electronic book, such as page 1, is displayed. In a lower portion 302 of the display 110 of the user device 100, a second non-consecutive page, such as page 10, of the electronic book that is displayed in the upper portion is displayed. The other aspects of the electronic book application, described with respect to FIGS. 1 and 2 may likewise be incorporated into the electronic book application executed on the user device 100 of FIG. 3. Thus, for example, the user device 100 of FIG. 3 may be configured to change the display from a portrait orientation to a landscape orientation when the user device 100 is rotated. Additionally, for example, any of the interactive controls (e.g., navigating, annotating, searching, bookmarking, etc.) described with respect to FIGS. 1 and 2 may likewise be used in conjunction with the electronic book application of FIG. 3.

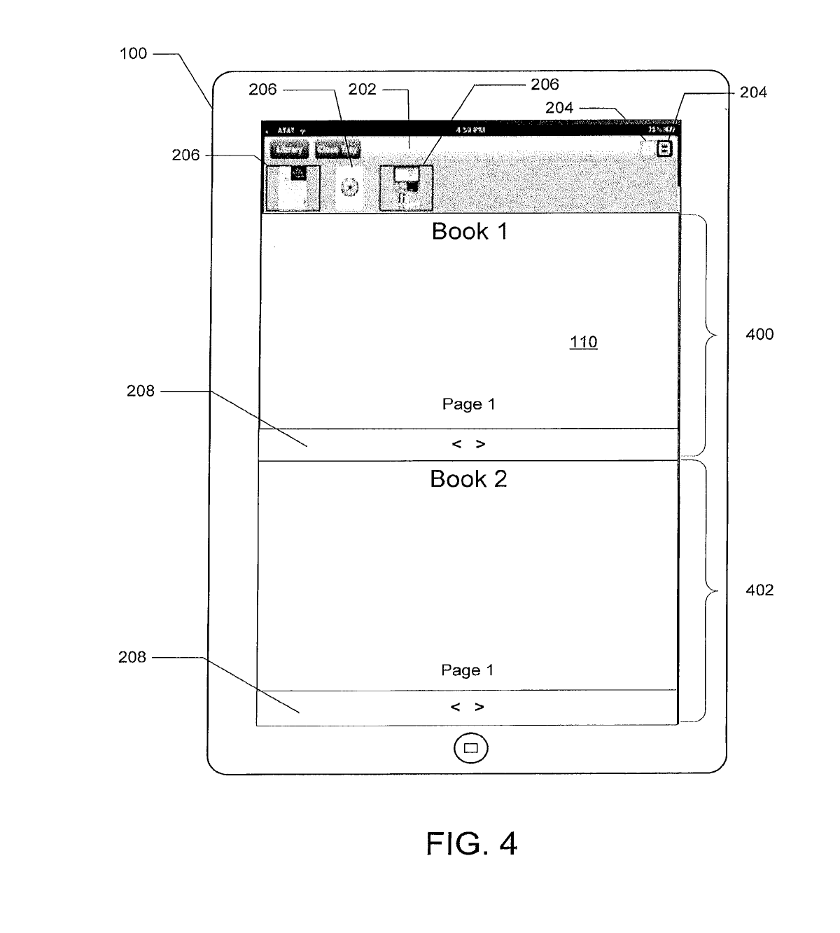

FIG. 4 illustrates an embodiment of the user device 100 where pages of different electronic books are simultaneously displayed on the user device 100. In an upper portion 400 of the display 110 of the user device 100 a page of a first electronic book, such as page 1, is displayed. In a lower portion 402 of the display 110 of the user device 100, a page, such as page 1, of an unrelated second electronic book that is displayed in the upper portion is displayed. The other aspects of the electronic book application, described with respect to FIGS. 1 and 2 may likewise be incorporated into the electronic book application executed on the user device 100 of FIG. 4. Thus, for example, the user device 100 of FIG. 4 may be configured to change the display from a portrait orientation to a landscape orientation when the user device 100 is rotated. Additionally, for example, any of the interactive controls (e.g., navigating, annotating, searching, bookmarking, etc.) described with respect to FIGS. 1 and 2 may likewise be used in conjunction with the electronic book application of FIG. 4.

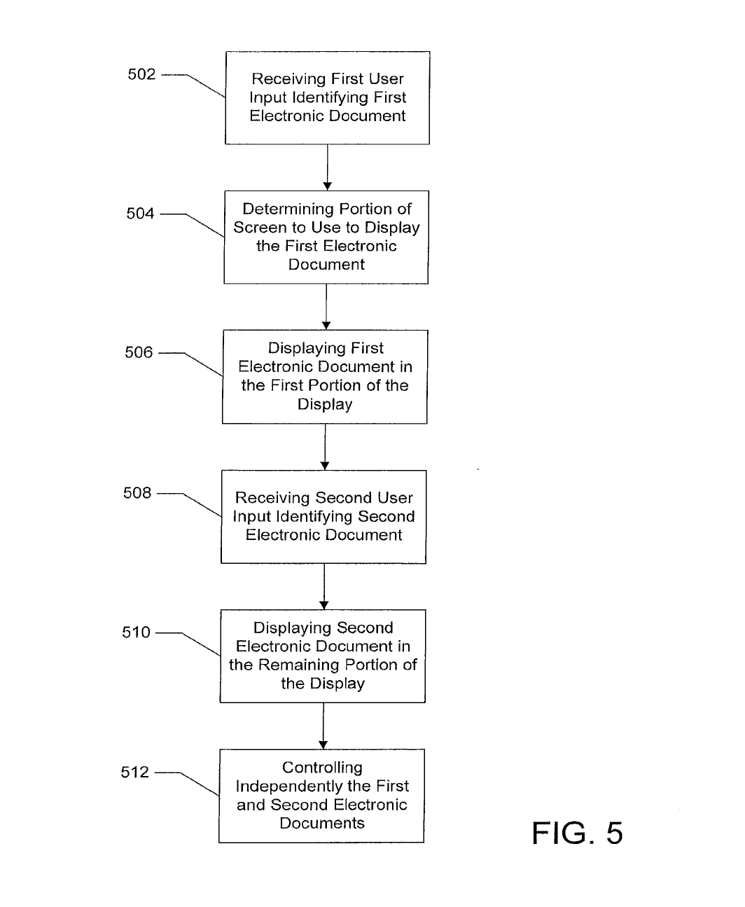

FIG. 5 is an exemplary flow diagram that displays multiple documents through an electronic application on a user device. At 502 the user device processor may receive a first user input identifying a first electronic document to display. In response to the first user input, the processor, at 504, determines a scaled down portion of the display in which the first electronic document is to be automatically displayed. In some instances, the processor may be configured to display the first electronic document in a portion of the display that is approximately 50 percent of the available viewing area of the display. In other instances, a user may configure a user device display setting, such as through a settings menu, to configure an alternate display portion for the first electronic document. The alternate display portion may be greater or less than the approximately 50 percent setting, but is less that all of the viewable display area of the user device. Information about the total size of the viewable area of the display may be available to the processor either through information retained in a memory of the user device, or through a query by the processor to the display. After determining what portion of the viewable display is to be used to display the first electronic document, the processor, at 506, automatically (e.g., without any additional user input) displays the first electronic document in the determined viewing area.

A second user input identifying a second electronic document to be displayed is received by the processor at 508. The second electronic document may be the same document as the first electronic document, or may be a completely different document. In response to the second use input, the processor, at 510, causes the second electronic document to be displayed in the remaining portion of the viewable area of the user device. When the second document is the same as the first electronic document, the second document may initially be displayed on the user device at the same or a different page as the first document.

Once the first electronic document and the second electronic document are simultaneously displayed on the user device, each document may be independently responsive to additional user inputs, at 512, in the respective portions of the user display that correspond to each document. Thus, a user may be able to independently navigate each electronic document such that non-consecutive pages of the same electronic document or different pages of different electronic documents are simultaneous displayed on the user device. Through independent processing of inputs for each document, a user may independently navigate, annotate, highlight, bookmark, etc. each electronic document.

Although FIGS. 2-5 describe a user device where a first electronic document and a second electronic document arc simultaneously displayed, and a user can independently interact with either of the documents, this disclosure contemplates operating a user device and displaying more than two electronic documents. Where the display is of sufficient size and display characteristics permit, additional documents, such as three, four, or more may be displayed and controlled in accordance with this disclosure.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A non-transitory computer-readable medium storing instructions for implementing a multi-document display, the instructions configured to cause a processor to:
receive a first message at a user device representing a first electronic document to be displayed in a first portion of a viewable display area of the user device;
automatically size the first electronic document to fill the first portion of the viewable display area, the first portion of the viewable display area being less than all of the viewable display area of the user device;
receive a second message at the user device representing a second electronic document to be displayed in a second portion of the viewable display area of the user device; and
automatically size the second electronic document to fill the second portion of the viewable display area, the second portion of the viewable display area being a difference between the viewable display area and the first portion of the viewable display area.

2. The non-transitory computer-readable medium of claim 1, where the first portion of the viewable display area and the second portion of the viewable display area are independently responsive to user input commands to control the first electronic document and the second electronic document, respectively.

3. The non-transitory computer-readable medium of claim 1, where the first message is received through a touch sensitive input device.

4. The non-transitory computer-readable medium of claim 3, where the second message is received through the touch sensitive input device.

5. The non-transitory computer-readable medium of claim 1, further configured to display a navigation tool bar in the first portion of the viewable display area in response to a single user input that coincides with a non-margin area of the first portion of the viewable display area, the navigation tool bar comprising a change page interface.

6. The non-transitory computer-readable medium of claim 5, further configured to change a displayable page of the first electronic document in response to an input received at the change page interface.

7. The non-transitory computer-readable medium of claim I, further configured to display a navigation tool bar in the second portion of the viewable display area in response to a single user input that coincides with a non-margin area of the second portion of the viewable display area, the navigation tool bar comprising a change page interface.

8. The non-transitory computer-readable medium of claim 7, further configured to to change a displayable page of the first electronic document in response to an input received the change page interface.

9. The non-transitory computer-readable medium of claim 1, further configured to reposition a viewable portion of the first electronic document in response to an input dragged across a non-margin area of the first portion of the viewable display area.

10. The non-transitory computer-readable medium of claim 1, further configured to reposition a viewable portion of the second electronic document in response to an input dragged across a non-margin area of the second portion of the viewable display area.

11. A method performed by a processor associated with an electronic book application, the method comprising:
receiving a first message at a processor of a user device, the first message representing a first electronic document to be displayed in a first portion of a viewable display area of the user device;
automatically sizing the first electronic document to fill the first portion of the viewable display area, the first portion of the viewable display area being less than all of the viewable display area of the user device;
receiving a second message at the processor of the user device, the second message representing a second electronic document to be displayed in a second portion of the viewable display area of the user device; and
automatically sizing the second electronic document to fill the second portion of the viewable display area, the second portion of the viewable display area being a difference between the viewable display area and the first portion of the viewable display area.

12. The method of claim 11, where the first portion of the viewable display area and the second portion of the viewable display area are independently responsive to user input commands to control the first electronic document and the second electronic document, respectively.

13. The method of claim 11, where the first message is received through a touch sensitive input device.

14. The method of claim 13, where the second message is received through the touch sensitive input device.

15. The method of claim 11, further comprising the processor causing a navigation tool bar to be displayed in the first portion of the viewable display area in response to a single user input that coincides with a non-margin area of the first portion of the viewable display area, the navigation tool bar comprising a change page interface.

16. The method of claim 15, further comprising the processor changing a displayable page of the first electronic document in response to an input received at the change page interface.

17. The method of claim 11, further comprising the processor causing a navigation tool bar to be displayed in the second portion of the viewable display area in response to a single user input that coincides with a non-margin area of the second portion of the viewable display area, the navigation tool bar comprising a change page interface.

18. The method of claim 17, further comprising the processor changing a displayable page of the first electronic document in response to an input received the change page interface.

19. The method of claim 11, further comprising the processor causing a viewable portion of the first electronic document to be repositioned in response to an input dragged across a non-margin area of the first portion of the viewable display area.

20. The method of claim 11, further comprising the processor causing a viewable portion of the second electronic document to be repositioned in response to an input dragged across a non-margin area of the second portion of the viewable display area.
